(19) United States
(12) Patent Application Publication
(10) Pub. No.: US 2011/0061795 A1
(43) Pub. Date: Mar. 17, 2011

(54) METHOD FOR PRODUCING A STOPPER

(75) Inventor: Werner Erni, Buron (CH)

(73) Assignee: Lonstroff AG

(21) Appl. No.: 12/882,750

(22) Filed: Sep. 15, 2010

(30) Foreign Application Priority Data
Sep. 16, 2009 (EP) 09 011 781.3

(51) Int. Cl. B32B 37/24

(52) U.S. Cl. 156/242

(57) ABSTRACT

Method for producing a one-piece stopper with a carrier body of an elastomeric material and an inert layer, the carrier body having a disk-shaped outer portion and an inner portion that protrudes in the manner of a spigot from the outer portion. The inner portion is molded under the effect of heat in a molding tool from a sheet of elastomeric material and an inert film and subsequently punched out. The outer portion is molded onto the inner portion by means of injection molding, whereby the stopper is given its final form.

### FIELD OF THE INVENTION

The present invention relates to a method for producing a stopper for closing a container, in particular for closing a medicament container.

### BACKGROUND

Stoppers of various forms and of various materials are used for sealing and closing containers that are used in particular for storing medicaments. Generally, such stoppers consist of natural or synthetic rubber or of rubber-elastic or pure thermoplastics. These materials are subsumed hereafter by the term “elastomeric materials”.

The elastic properties of such stoppers of elastomeric materials are particularly advantageous in the case of medicament bottles, syringe cylinders or other containers, often consisting of glass, since on the one hand they allow compensation for the tolerance of such bottle openings or syringe cylinders and on the other hand it is also possible to pierce the stopper by means of a cannula and in this way remove the container content or fill the container. The stoppers ensure good, dependable sealing of the container over a relatively long period of time.

The generally liquid or powdered pharmaceutical preparations that are to be stored in medicament bottles, syringe cylinders or similar containers impose very different requirements on the stopper material to be used. For example, the chemical and/or biological compatibility required by the bottle content. Furthermore, in the case of bottle contents that are sensitive to oxygen or moisture, the gas or water vapor permeability of the closure stopper is important. Furthermore, the stopper material must not cause any alteration of the therapeutic value of the container content, for example by giving off substances from the content that are harmful or alter a pharmaceutical preparation or by taking up constituents of the pharmaceutical preparation.

The problems set out above also apply equally to plungers of syringe cylinders, syringe ampoules and/or two-chamber syringe ampoules.

EP 0 148 426 discloses pharmaceutical stoppers for closing or subdividing a container that both ensure good sealing and reliably avoid interaction between the stopper material and the container content. The stoppers according to EP 0 148 426 substantially consist of rubber and have a region which faces the container content in the position for use and is enclosed by an inert film in the form of a cap. In a non-coated region adjacent to the inert film, the stopper neck lies directly against the wall of the container opening. In the case of such a stopper, in practice the container content only comes into contact with the inert film, while the uncoated region of the stopper neck with its rubber-elastic material provides a good seal against the inner wall of the container.

EP 0 148 426 also discloses a method for producing the stoppers described above. In this method, a rubber film—onto which, for example, a fluorinated polymer film has previously been laminated—is introduced as an initially planar composite into a molding tool and deformed there by means of pressure and heat—for example in a thermoforming process—into the form intended for the inner stopper part. The polymer film thereby bonds firmly with the rubber film and the latter is at least partially vulcanized. In the second working step, the inner stopper parts are removed from the molding tool and punched out. Subsequently, the outer parts of the stopper are placed with the inner parts of the stopper into a second molding tool and molded there, fully vulcanized together and bonded to one another. The finished stoppers are obtained by renewed punching out.

The above method for producing stoppers has the disadvantage that it is relatively complex and comprises many working steps. It is therefore an object of the present invention to provide a more efficient method for producing stoppers.

### BRIEF SUMMARY OF THE INVENTION

The object is achieved by the method according to claim 1. Other embodiments are claimed in the dependent claims.

The method according to various embodiments of the invention serves for producing a one-piece stopper with a carrier body of an elastomeric material and an inert layer, which stopper is intended for closing a container with an opening, in particular with a substantially circular opening. The carrier body of the stopper has a disk-shaped outer portion and a spigot-like inner portion, which is firmly connected to the outer portion, protrudes from the outer portion and has a free end remote from the outer portion. Preferably, the outer portion and the inner portion have a common center axis. The outer portion is intended for resting on the outer side of the container, and the inner portion is intended for being inserted with the free end in front into the opening of the container and protruding into the interior of the container. The surface of the inner portion is at least partially coated with an inert layer, so that contact of the carrier body with the content of the container can be at least almost completely avoided.

By analogy with the method according to EP 0 148 426, the production method may comprises the following steps:
(a) placing a sheet of the elastomeric material and an inert film into a molding tool,
(b) molding the inner portion under the effect of heat, so that the inert film forms the inert layer and coats the free end of the inner portion and an adjacent region, the elastomeric material being at least partially vulcanized and inseparably bonded to the inert film, and a skin being formed,
(c) removing the skin from the molding tool,
(d) punching out the inner portion from the skin, and
(e) attaching the outer portion in a further molding tool.

The method according to various embodiments of the invention is characterized in that, to attach the outer portion,
(e1) the inner portion is placed into a cavity of an injection mold in such a way that a molding-on end opposite from the free end is exposed in the cavity,
(e2) the outer portion is molded by means of injection molding onto the molding-on end of the inner portion, whereby the stopper is given its final form, and
(e3) the fully vulcanized or at least partially cured stopper is removed from the injection mold.

The method according to various embodiments of the invention allows the attachment of the outer portion to the inner portion to be significantly simplified: while in the case of the method according to EP 0 148 426, two further molding working steps—thermoforming and punching out—are necessary, in the case of the method according to the invention the outer portion is completely molded and bonded to the inner portion in a single injection-molding operation. It has consequently been possible to reduce the number of working steps and make the production method shorter, less complex and more efficient.

This sheet of elastomeric material that is placed in the molding tool in step (a) is not completely vulcanized, i.e. it is partially vulcanized or unvulcanized. The sheet is preferably unvulcanized.

In a preferred embodiment, the carrier body of the stopper is produced from a natural or synthetic rubber material. The use of a rubber material for the carrier body ensures an optimum sealing function of the stopper. Bromobutyl rubber, nitrile rubber (NBR) or ethylene-propylene-diene rubber (EPDM), in particular bromobutyl rubber, is preferably used as the elastomeric material. These materials are particularly suitable since they are gas-impermeable and chemically relatively inert.

In a preferred embodiment, a fluorinated polymer film is used as the inert film. Fluorinated polymer films are chemically very inert and resistant and can therefore prevent an interaction between the container content and the stopper material. This avoids impairment of the container content, which is of great importance particularly in the case of pharmaceutical preparations. Fluorinated polymer films of polytetrafluoroethylene (Teflon®, PTFE), tetrafluoroethylene perfluoropropylene copolymer (FEP), perfluoroalkoxy copolymer (PFA), ethylene tetrafluoroethylene copolymer (ETFE), polyvinylidene fluoride (PVDF) or polyvinyl fluoride (PVF), are preferably used, in particular a Teflon film.

In a preferred embodiment, the inner portion is molded in step (b) at a temperature of 120° C. to 250° C., preferably at a temperature of 150° C. to 200° C., in particular at approximately 180° C. Heat is preferably transferred through the molding tool. Preferably, in step (b), a pressure is additionally exerted on the sheet of elastomeric material and the inert film.

In a preferred embodiment, in step (b), the inert layer is molded in such a way that it completely coats the outer surface of the inner portion that protrudes from the outer portion of the finished spigot. In this way, the entire portion that is introduced into the opening of the container is therefore coated with the inert layer on the finished spigot and the container content does not come into any contact with the material of the carrier body. In this manner, impairment of the container content by the stopper can be completely avoided.

In a preferred embodiment, in step (b), a depression is formed on an end face lying at the free end of the inner portion. This reduces the thickness of the stopper in the region of the depression, so that it can be pierced more easily with a cannula. Moreover, such a depression at the free end of the inner portion allows the formation of an elastic sealing lip, which additionally improves the sealing function of the stopper.

In a preferred embodiment, in step (b), a peripheral annular groove is formed in an extreme end face lying at the molding-on end of the inner portion and is open toward the end face. This annular groove has the effect of increasing the size of the contact area between the inner portion and the outer portion and thereby improving the bonding of the outer portion to the extreme end face of the inner portion.

In a preferred embodiment, in step (e1), the inner portion is placed in the cavity of the injection mold in such a way that a region adjacent to the molding-on end is exposed. This arrangement in the cavity has the effect that, during the injection molding, not only the molding-on end of the inner portion is molded on axially but also the exposed, circumferential region adjacent thereto is molded on in the radial direction. This in turn has the effect of increasing the size of the contact area between the inner portion and the outer portion and improving the bonding of the outer portion to the inner portion.

In a preferred embodiment, in step (e1), the inner portion is placed in the cavity of the injection mold in such a way that only that region at the molding-on end of the inner portion that is not coated with the inert layer, i.e. that region that is free from the inert layer, is exposed. In this manner, the contact area between the two parts of the carrier body belonging to the inner portion and the outer portion is maximized and at the same time the carrier body itself is prevented from coming into contact with the container content during use.

In a further preferred embodiment, a negative pressure is produced in the injection mold before the molding on of the outer portion. The negative pressure has the effect that as much air as possible is removed from the cavity of the injection mold before the injection molding and the injection-molding operation is made easier. For this purpose, the injection mold is preferably evacuated by means of an external device via a negative pressure channel, which is connected to the cavity. In order that the air can be expelled up until immediately before the injection-molding operation, the injection mold preferably has a closing valve, which is brought into the closed position by the molding material itself and prevents the molding material from penetrating into the negative pressure channel during the injection-molding operation. The production of a negative pressure in the injection mold also serves the purpose of avoiding the inclusion of air bubbles in the molded-on outer portion and thus improving the quality of the product.

In a preferred embodiment, in step (e2), an injection pressure of 800 to 1400 bar, preferably of 1000 to 1200 bar, in particular of approximately 1100 bar, is used for the molding on of the outer portion.

### BRIEF DESCRIPTION OF THE SEVERAL VIEWS OF THE DRAWINGS

The present invention is further illustrated on the basis of the schematic sectional representations shown in the following drawing, in which:

FIG. 1 shows a molding tool in the open position;

FIG. 2 shows the placement of a sheet of elastomeric material and an inert film in the molding tool;

FIG. 3 shows the molding of the inner portion from the elastomeric material and the inert film in the molding tool;

FIG. 4 shows the removal of the skin from the molding tool;

FIG. 5 shows the placement of the skin in a punching tool;

FIG. 6 shows the closing of the punching tool;

FIG. 7 shows the punching out of the inner portion;

FIG. 8 shows the injection mold in the open position;

FIG. 9 shows the placement of the inner portion in a cavity of the injection mold;

FIG. 10 shows the molding on of the outer portion;

FIG. 11 shows a stopper produced by the method according to the invention;

FIG. 12 shows a container with a stopper produced with the aid of the method according to the invention.

### DETAILED DESCRIPTION OF THE INVENTION

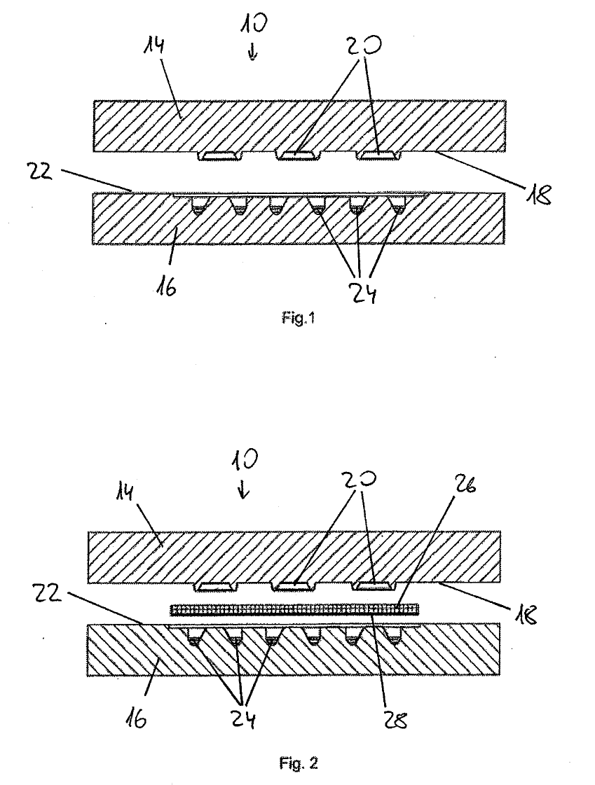

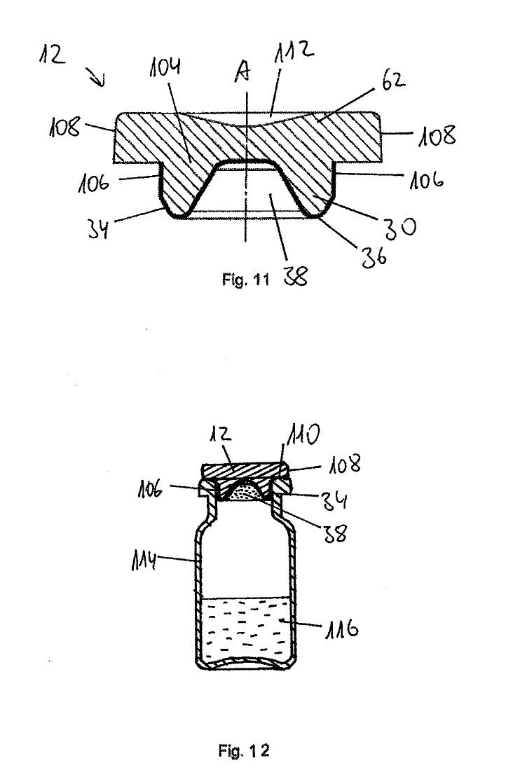

FIG. 1 schematically shows a section through a molding tool 10 in the open position, which can be used in the method according to the invention for the production of a stopper 12 (cf. FIG. 11). The molding tool 10 has a first mold plate 14 and, arranged parallel thereto, a second mold plate 16. The two mold plates 14 and 16 are movable with respect to one another, normal in relation to the planes of the plates. The first mold plate 14 has first mold impressions 20 on its side 18 facing the second mold plate 16. The second mold plate 16 has second mold impressions 24 on its side 22 facing the first mold plate 14. The individual first mold impressions 20 are arranged in such a way that they can interact with the second mold impressions 24 when the molding tool 10 is being used. In particular, a first mold impression 20 is respectively assigned to a second mold impression 24 and they are arranged one above the other in the direction normal to the planes of the plates.

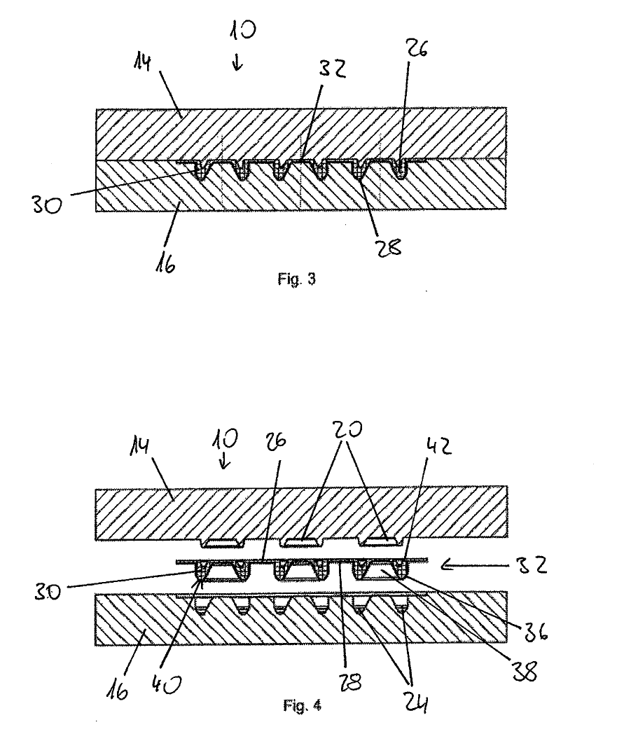

The section represented in FIG. 2 schematically shows the first step (a) of the method according to the invention, according to which a sheet 26 of an elastomeric material and an inert film 28 are placed in the molding tool 10. In this case, the elastomeric sheet 26 and the inert film 28 are arranged parallel to one another between the two mold plates 14 and 16. The elastomeric sheet 26 and the inert film 28 may be bonded to one another before placement, for example by the inert film 28 being laminated onto the sheet 26 of the elastomeric material. Alternatively, however, it is also possible for the sheet 26 and the inert film 28 to be placed in the molding tool 10 separately. In step (a), the elastomeric sheet 26 is arranged between the first mold plate 14 and the inert film 28, and the inert film 28 is arranged between the second mold plate 16 and the elastomeric sheet 26.

In FIG. 3, the molding of an inner portion 30 (cf. FIG. 11) according to step (b) of the method according to the invention is schematically represented. For this purpose, the molding tool 10 is closed around the sheet 26 of elastomeric material and the inert film 28, in that the first and second mold plates 14, 16 are moved with respect to one another, so that the elastomeric sheet 26 and the inert film 28 are together pressed into the mold impressions 20 and 24. Under the effect of heat, a skin 32 with a number of spigot-like inner portions 30 is thus formed, the elastomeric material being at least partially vulcanized and bonded to the inert film 28. The inert film 28 thereby forms an inert layer 34 (cf. FIG. 11), which coats the inner portions on the side facing the second mold plate 16.

FIG. 4 schematically shows a section through the molding tool 10, at the time when the skin 32 is removed from it. For this purpose, the molding tool 10 is in turn brought into an open position, so that the skin 32 can be detached from the mold impressions 20 and 24. The spigot-like inner portions 30, which are part of the skin 32, each have on the side of the skin that is facing the second mold plate 16 a free end 36 with a depression 38, which is formed in the end face 40 lying at the free end 36. The inner portions 30 also each have a molding-on end 42, which lies opposite from the free end 36. In the extreme end face lying at the molding-on end 42 of the inner portion 30 there is also formed a peripheral annular groove 44, which is open toward the end face.

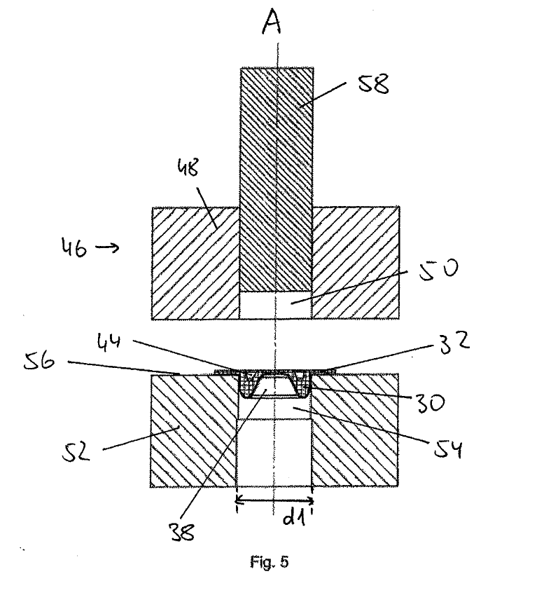

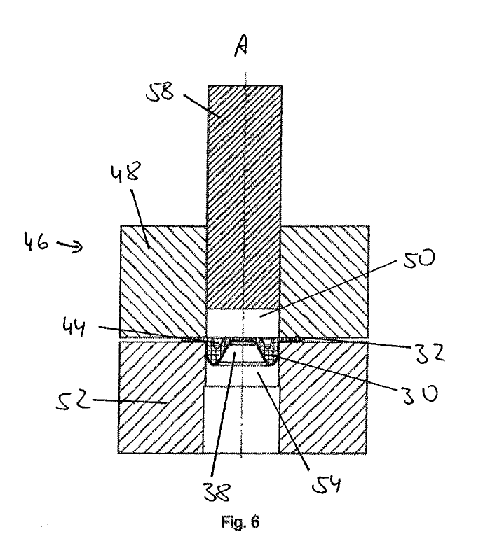

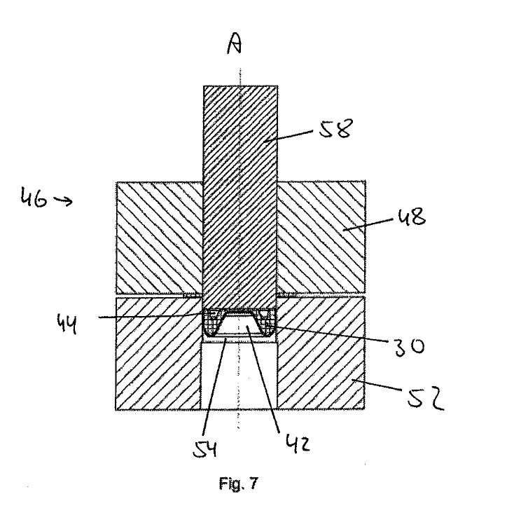

In step (d) of the method according to the invention, the inner portions 30 are then punched out from the skin 32. This operation is schematically shown in the sectional representation in FIGS. 5 to 7: the skin 32 (or part thereof) is placed in a punching tool 46 (FIG. 5), the punching tool 46 is closed (FIG. 6) and the inner portion 30 is punched out (FIG. 7).

The punching tool 46 has a first punching plate 48 with a first clearance 50 and, arranged parallel to the first punching plate 48, a second punching plate 52 with a second clearance 54, the two punching plates 48 and 52 being movable normal to the plane of the plates. The two circular-cylindrical clearances 50 and 54 run normal to the plane of the plate, have the same diameter d1 and are arranged in such a way that they form a continuous hollow space when the punching mold 46 is closed. The second punching plate 52 has a supporting surface 56 on its side facing the first punching plate 48. The skin 32 is placed on the supporting surface 56 in such a way that the inner portion 30 protrudes with the free end 36 in front into the second clearance 54. The spigot-shaped region protruding from the skin 32 into the second clearance 54 is substantially circular-cylindrical, has a center axis A and preferably has at least approximately the same diameter d1 as the two clearances 50 and 54.

The punching tool 46 has, furthermore, a circular-cylindrical punching ram 58, which is movable along the center axis A normal to the planes of the plates. The punching ram 58 is arranged in the first clearance 50 before the actual punching operation and has a diameter that is somewhat smaller in comparison with d1, for example 0.01 to 0.03 mm smaller. Before the punching out, the skin 32 is clamped in between the two punching plates 48 and 52 and thus fixed. For the punching out, the punching ram 58 is forced through the first clearance 50 into the second clearance 54 and thereby severs the skin 32 along the outer circumference of the inner portion 30.

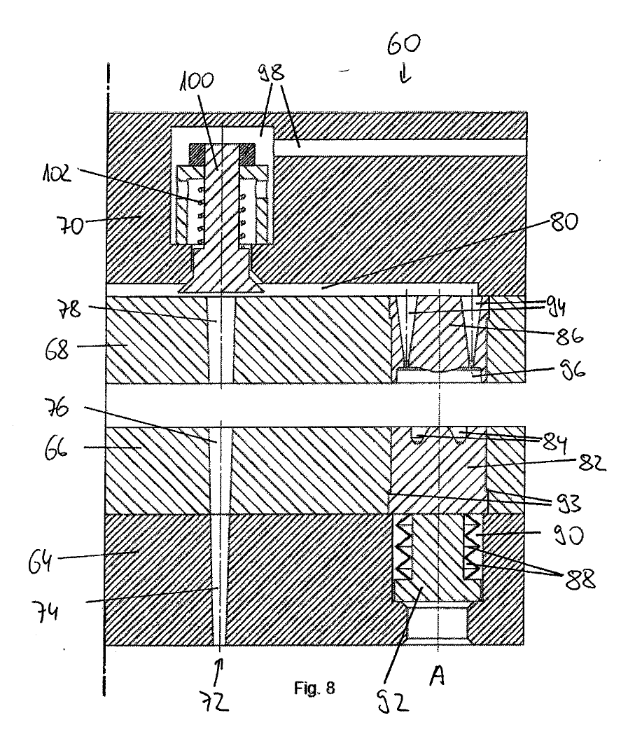

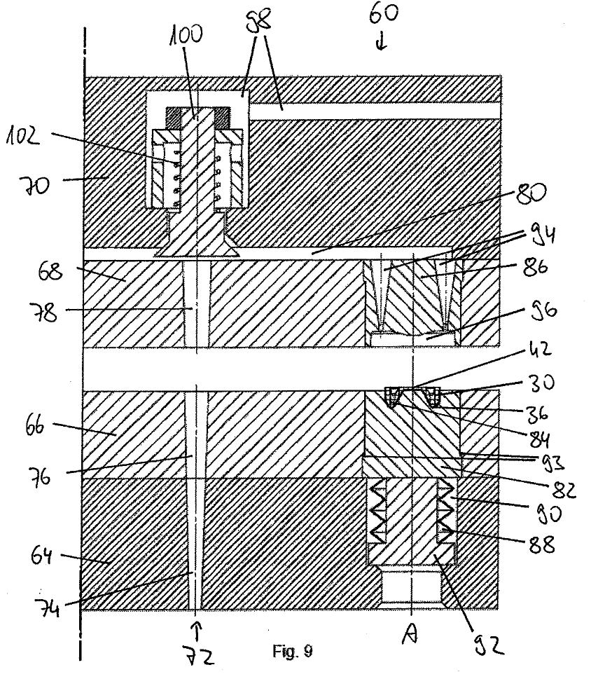

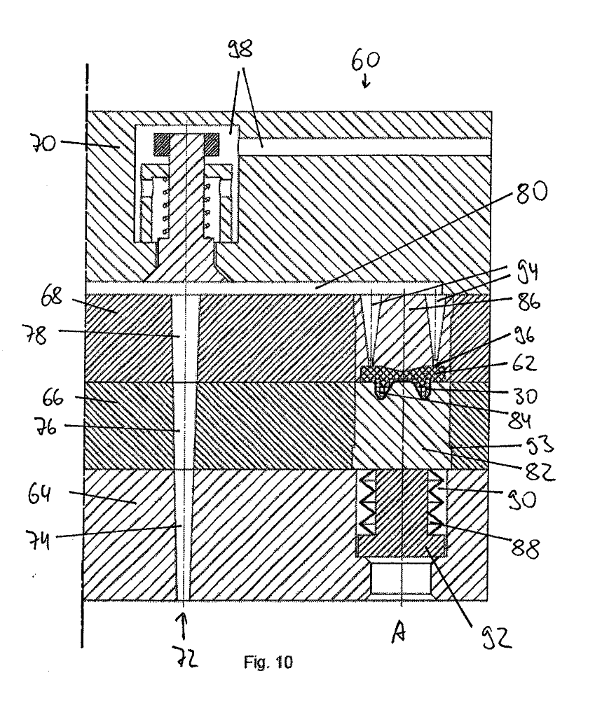

FIGS. 8 to 10 show a schematic section through an injection mold 60, which can be used in the case of the method according to the invention for molding on an outer portion 62 (cf. FIG. 11). FIG. 8 shows the injection mold 60 in the open position, FIG. 9 shows the placement of the inner portion 30 in the injection mold 60, and FIG. 10 shows the actual molding on of the outer portion 62.

The injection mold 60 has a first outer plate 64, a first inner plate 66, a second inner plate 68 and a second outer plate 70, which are all arranged parallel to one another and are movable normal to the planes of the plates. The two inner plates 66 and 68 are arranged between the outer plates 64 and 70. In the open position shown in FIG. 8, the first outer plate 64 and the first inner plate 66 are firmly connected to one another, and remain so during the entire method. In the open position shown in FIG. 8, the first inner plate 66 is at a distance from the second inner plate 68. The first inner plate 66 and the first outer plate 64 are stationarily connected to the injection mold 60.

The second inner plate 68 and the second outer plate 70 may, however, be moved in relation to one another and likewise moved away from the first inner plate 66 and the first outer plate 64, in particular during the demolding operation. During the injection molding operation, the second inner plate 68 and the second outer plate 70 are pressed against one another and the injection mold 60 is closed.

Running through the first outer plate 64 and the two inner plates 66 and 68 is a feed channel 72 for feeding in the molding material, which is made up of the three feed channel portions 74, 76 and 78 respectively arranged in one of the three plates 64, 66 and 68. Running at right angles to the feed channel 72, between the second inner plate 68 and the second outer plate 70, is at least one, preferably flat-form, runner 80, through which the molding material can be passed to the cavities of the injection mold 60.

Inserted in the first inner plate 66 is an exchangeable first mold insert 82, which has a first part-cavity 84, which is open toward the second inner plate 68. Inserted in the second inner plate 68 is an exchangeable second mold insert 86, which has a second part-cavity 84, which is open toward the first inner plate 66. The first part-cavity 84 and the second part-cavity 96 are arranged along a center axis A running normal to the planes of the plates and, when the injection mold 60 is closed, form the cavity of the injection mold 60. The first mold insert 82 is prestressed in the first inner plate 66 by disk springs 88, which are inserted in a hollow space 90 in the first inner plate 66 and are arranged around a guiding cylinder 92 running along the center axis A. The first mold insert 82 lies against the first inner plate 66 by means of outer radial shoulders 93 and is kept in position by the spring force of the disk springs. In the open position shown in FIG. 8, the first mold insert 82 protrudes slightly from the first inner plate 66. When the injection mold 60 is closed, the first mold insert 82 is pushed back, and consequently achieves a neat form-fitting connection. The second mold insert 86 is fixed in the second inner plate 68 by the second outer plate 70. The second inner mold insert 86 also has injection channels 94, which connect the runner 80 to the second part-cavity 96.

Arranged in the second outer plate 70 is a negative pressure channel 98, by means of which air is removed from the closed injection mold 60 before the molding material is introduced. This produces a negative pressure on the cavities of the closed injection mold 60. The negative pressure channel 98 can be closed by means of a closing valve 100, which is kept open by a spiral spring 102. The closing valve 100 shown is brought into the closed position by means of back pressure by the molding material itself as soon as the latter is introduced into the mold, so that the molding material is prevented from penetrating into the negative pressure channel 98 during the injecting operation.

To mold on the outer portion 62 (cf. FIG. 10), the punched-out inner portion 30 is placed in the first part-cavity 84 in such a way that the molding-on end 42 is exposed in the cavity and the region toward the free end 36 is completely enclosed by the first part-cavity 84 (FIG. 9). Preferably, the inner portion 30 is placed in such a way that a cylindrical region adjacent to the molding-on end 42 is also exposed in the cavity, so that the inner portion 30 can be molded on not only axially from the molding-on end 42 but also radially in the exposed region. After the injection mold 60 is closed, the molding material is injected and passes through the feed channel 72 via the runner 80 and the injection channels 94 into the second part-cavity 96, where the outer portion 62 is formed. During the injection, the closing valve 100 is closed. The stopper 12 (cf. FIG. 11) is given its final form by this injection molding and can be removed from the injection mold 60 as soon as it is vulcanized or at least partially cured. In order to remove the stopper 12 from the injection mold 60, first the second inner plate 68 and the second outer plate 70 are moved in relation to the first inner plate 66 and the first outer plate 64. In this step, the inner portion 30 or the partially cured finished stopper 12 becomes detached from the first mold insert 82. Subsequently, by means of a hydraulic or electric drive, the second inner plate 68 is separated from the second outer plate 70 or moved apart in relation thereto. This has the effect that the molding material that has remained in the runner 80 and the injection channels 94 is separated from the second outer plate 70. The stopper 12 can then be separated from the molding material that has remained in the injection channels 94. Subsequently, the remaining molding material is removed from the injection mold 60 together with the sprue remaining in the third feed channel portion 78.

FIG. 11 schematically shows a section through a stopper 12, which has been produced by means of the method according to the invention. The stopper 12 has a carrier body 104 and an inert layer 34, which coats the carrier body 104 in the region of the inner portion 30. The inner portion 30 of the stopper 12 has a free end 36, which is remote from the outer portion 62 and in the extreme end of which a depression 38 has been introduced. Moreover, the inner portion 30 has a casing-like sealing surface 106, which is adjacent to the outer portion 62 and is completely coated with the inert layer 34. The disk-shaped outer portion 62 has a lateral surface 108 and, arranged normal thereto, an annular supporting surface 110, which is adjacent to the inner portion 30. On the side remote from the inner portion 30, the outer portion 62 also has a recess 112, which together with the depression 38 serves the purpose of making it easier for the stopper 12 to be pierced with a cannula.

FIG. 12 schematically shows a section through a stopper 12, which has been fitted onto a container 114. The container 114 has been filled with a content 116, in particular a pharmaceutical composition, and is closed by the stopper 12. The annular supporting surface 110 of the stopper 12 rests on the upper rim of the container 114, while the casing-like sealing surface 106 of the stopper 12 lies against the inner side of the container wall and seals the container. The inert layer 34 completely coats that region of the stopper 12 that is arranged in the interior of the container 114 and thus prevents the content 116 of the container 114 from coming into contact with the material of the carrier body 104 of the stopper 12.

1. A method for producing a one-piece stopper with a carrier body of an elastomeric material and an inert layer, which stopper is intended for closing a container with an opening, the carrier body having a disk-shaped outer portion, which is intended to rest on the outer side of the container, and an inner portion, which is firmly connected to the outer portion, protrudes in the manner of a spigot from the outer portion, has a free end (36) remote from the outer portion and is intended for being inserted with the free end in front into the opening of the container and protruding into the interior of the container, and the surface of which is at least partially coated with the inert layer,
comprising the steps of:
(a) placing a sheet of the elastomeric material and an inert film into a molding tool,
(b) molding the inner portion under the effect of heat, so that the inert film forms the inert layer and coats the free end of the inner portion and an adjacent region, the elastomeric material being at least partially vulcanized and inseparably bonded to the inert film, and a skin being formed,
(c) removing the skin from the molding tool,
(d) punching out the inner portion from the skin, and
(e) attaching the outer portion in a further tool,
characterized in that, to attach the outer portion
(e1) the inner portion is placed in a cavity of an injection mold in such a way that a molding-on end opposite from the free end is exposed in the cavity,
(e2) the outer portion is molded by means of injection molding onto the molding-on end of the inner portion, whereby the stopper is given its final form, and
(e3) the fully vulcanized or at least partially cured stopper is removed from the injection mold.

2. The method as claimed in claim 1, characterized in that bromobutyl rubber, nitrile rubber or ethylene-propylene-diene rubber is used as the elastomeric material.

3. The method as claimed in claim 1, characterized in that a fluorinated polymer film is used as the inert film.

4. The method as claimed in claim 1, characterized in that, in step (b), the inert layer (34) is molded in such a way that it completely coats the outer surface of the inner portion that protrudes from the outer portion on the finished stopper.

5. The method as claimed in claim 1, characterized in that, in step (b), a depression is formed on an end face lying at the free end of the inner portion.

6. The method as claimed in claim 1, characterized in that, in step (b), a peripheral annular groove is formed in an extreme end face lying at the molding-on end of the inner portion, the groove being open toward the end face.

7. The method as claimed in claim 1, characterized in that, in step (e1), the inner portion is placed in the cavity of the injection mold in such a way that a lateral region adjacent to the molding-on end is exposed.

8. The method as claimed in claim 1, characterized in that, in step (e1), the inner portion is placed in the cavity of the injection mold in such a way that only that region at the molding-on end of the inner portion that is free from the inert layer is exposed.

9. The method as claimed in claim 1, characterized in that a negative pressure is produced in the injection mold before the molding on of the outer portion.

10. The method as claimed in claim 3, characterized in that a fluorinated polymer film is a Teflon film.
